(19) United States
(12) Patent Application Publication
(10) Pub. No.: US 2011/0314301 A1
(43) Pub. Date: Dec. 22, 2011

(54) SYSTEMS AND METHODS FOR HARDWARE KEY ENCRYPTION

(75) Inventors: Garry R. Elder, Rockwall, TX (US); Ramanujam Thodur, Bangalore (IN)

(73) Assignee: Texas Instruments Incorporated, Dallas, TX (US)

(21) Appl. No.: 13/215,763

(22) Filed: Aug. 23, 2011

Related U.S. Application Data
(62) Division of application No. 11/859,131, filed on Sep. 21, 2007.

(51) Int. Cl. G06F 12/14

(52) U.S. Cl. 713/189

(57) ABSTRACT

Various systems and methods for implementing dynamic logic are disclosed herein. For example, some embodiments of the present invention provide systems for encrypting/decrypting data. Such systems include a hardware key, a memory, a hardware decoder and a message encoder. The memory includes an encoded encoding key that represents an original encoding key. The hardware decoder receives a portion of the encoded encoding key and decodes the portion of the encoded encoding key using the hardware key to recover a portion of the original encoding key. The message encoder receives a data set and the portion of the original encoding key and encodes the data set using the portion of the original encoding key to create an encoded data set.

### CROSS-REFERENCE TO RELATED APPLICATIONS

This application is a divisional of U.S. patent application Ser. No. 11/859,131, which was filed on Sep. 21, 2007 and which is incorporated by reference herein for all purposes.

### BACKGROUND OF THE INVENTION

The present invention is related to encryption, and more particularly to systems and methods for hardware based encryption.

Encryption is typically applied to render data inaccessible to an unauthorized recipient. In a typical encryption scheme, data is encoded using a known key. The encoded data is then provided to a recipient who has a corresponding decoding key. The recipient can use the decoding key to decode the received data and thereby generate the original data set. It is difficult for a recipient who does not have the decoding key to hack into the encoded data.

FIG. 1 shows an exemplary prior art encoding/decoding system 100. Encoding/decoding system 100 includes a processor 110 with two software modules: an encoding module 120 and a message generator 140. In addition, processor 110 includes an encoding key 130. Encoding/decoding system 100 includes a hardware device 150 that includes a flash memory 160 and a decoding module 170. A decoding key 180 is stored in flash memory 160.

In operation, a particular message is generated by a message generator 140 executed by processor 110. The generated message is encoded by executing encoding module 120 using encoding key 130. The encoded message is then sent to hardware device 150 across a data bus 190. Hardware device 150 receives the encoded message and provides it to decoding module 170. Decoding module 170 accesses decoding key 180 from flash memory 160, and decodes the encoded message using decoding key 180 to recover the original message generated by processor 110.

Data retrieved from data bus 190 is encoded and therefore difficult to access without decoding key 180. Decoding key 180 may be accessed by reverse engineering the contents of flash memory 160. In particular, a hacker may obtain hardware device 150, open it and perform one or more tests on flash memory 160 to identify decoding key 180. Thus, decoding key 180 may be obtained using relatively simple hardware reverse engineering techniques. Accessing decoding key 180 would make the otherwise inaccessible data available to an unauthorized recipient.

Thus, for at least the aforementioned reason, there exists a need in the art for advanced systems and methods for encrypting information.

### BRIEF SUMMARY OF THE INVENTION

The present invention is related to encryption, and more particularly to systems and methods for hardware based encryption.

Various embodiments of the present invention provide systems for encrypting/decrypting data. Such systems include a hardware key, a memory, a hardware decoder and a message encoder. The memory includes an encoded encoding key that represents an original encoding key. The hardware decoder receives a portion of the encoded encoding key and decodes the portion of the encoded encoding key using the hardware key to recover a corresponding portion of the original encoding key. The message encoder receives a data set and the portion of the original encoding key, and encodes the data set using the portion of the original encoding key to create an encoded data set. In some instances of the aforementioned embodiments, the portion of the encoded encoding key is the entirety of the encoded encoding key and the recovered portion of the original encoding key is the entirety of the original encoding key. In various instances of the aforementioned embodiments, the systems further include a hardware encoder that receives the portion of the original encoding key and encodes it using the hardware key to create the portion of the encoded encoding key. A memory access module may also be included to receive the portion of the encoded encoding key and write it to the memory. The aforementioned hardware decoder may implement a shifting decryption scheme, a logical combination decryption scheme, or some other known decryption scheme.

In other instances of the aforementioned embodiments, the portion of the encoded encoding key is a first portion of the encoded encoding key and the portion of the original encoding key is a first portion of the original encoding key. In such instances, two hardware decoders and two hardware keys may be included. In such systems, a first of the hardware decoders receives the first portion of the encoded encoding key and a second of the hardware decoders receives a second portion of the encoded encoding key. The first hardware decoder decodes the first portion of the encoded encoding key using the first hardware key, and the second hardware decoder decodes the second portion of the encoded encoding key using the second hardware key. In such cases, the message combines the two portions of the decoded encoding key to recover the original encoding key, and to encode the data set using the recovered original encoding key. In some such cases, the first hardware key and the second hardware key are equivalent, while in other such cases the two hardware keys are distinct.

In various cases, the systems further include a first hardware encoder and a second hardware encoder. In such cases, the first hardware encoder receives the first portion of the original encoding key and encodes it using the first hardware key to create the first portion of the encoded encoding key. The second hardware encoder receives the second portion of the original encoding key and encodes it using the second hardware key to create the second portion of the encoded encoding key. A memory access module may also be included to receive the first and second portions of the encoded encoding key and to write them to the memory. In some instances, the first hardware encoder implements a first encoding algorithm and the first hardware decoder implements a first decoding algorithm that reverses the first encoding algorithm. The second hardware encoder implements a second encoding algorithm and the second hardware decoder implements a second decoding algorithm that reverses the second encoding algorithm. In some such cases, the first encoding algorithm is distinct from the second encoding algorithm.

Other embodiments of the present invention provide systems for authenticating one device to another. Such systems include a processor associated with a first memory. The first memory includes an encoding key and instructions executable to: provide a data set, encode the data set using the encoding key to create a first encoded data set, receive a second encoded data set, and compare the first encoded data set against the second encoded data set. The systems further include a hardware key and a second memory. The second memory includes an encoded encoding key that represents the encoding key. A hardware decoder receives a portion of the encoded encoding key and decodes the portion of the encoded encoding key using the hardware key to recover a portion of the encoding key. A message encoder receives the data set and the portion of the encoding key and encodes the data set using the portion of the encoding key to create the second encoded data set.

Yet other embodiments of the present invention provide methods for authenticating one device to another. Such methods include providing a first device and a second device. The first device includes a hardware key, a memory, and a hardware decoder. The memory includes an encoded encoding key that represents an original encoding key. The second device includes the original encoding key. The methods further include generating a data set that is made available to the second device, and encoding the data set in the second device using the original encoding key to create a second encoded data set. The first device accesses the encoded encoding key from the memory, and decodes the encoded encoding key using the hardware decoder and the hardware key to recover the original encoding key. Additionally, the first device encodes the data set to create a first encoded data set. The first encoded data set is provided to the second device, and the second device compares the first encoded data set with the second encoded data set.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE SEVERAL VIEWS OF THE DRAWING

For a more complete understanding of the present invention, and the advantages thereof, reference is now made to the following descriptions taken in conjunction with the accompanying drawings, in which:

FIG. 1 depicts an exemplary prior art encryption/decryption system;

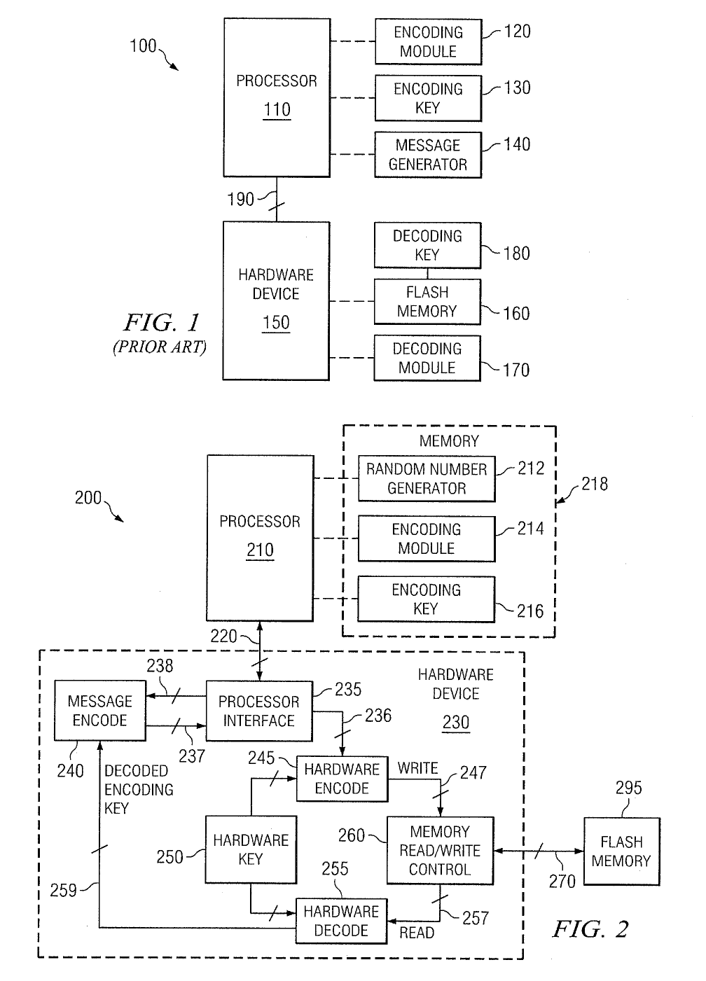

FIG. 2 depicts a hardware based encryption system utilizing a single hardware encoder/decoder pair in accordance with some embodiments of the present invention;

FIG. 3 is a flow diagram showing a method for device authentication using hardware based encryption in accordance with one or more embodiments of the present invention;

FIG. 4 depicts another hardware based encryption system utilizing multiple hardware encoder/decoder pairs in accordance with other embodiments of the present invention; and

FIG. 5 is a flow diagram showing another method for device authentication using hardware based encryption in accordance with other embodiments of the present invention.

### DETAILED DESCRIPTION

Refer now to the drawings wherein depicted elements are, for the sake of clarity, not necessarily shown to scale and wherein like or similar elements are designated by the same reference numeral through the several views.

The present invention is related to encryption, and more particularly to systems and methods for hardware based encryption.

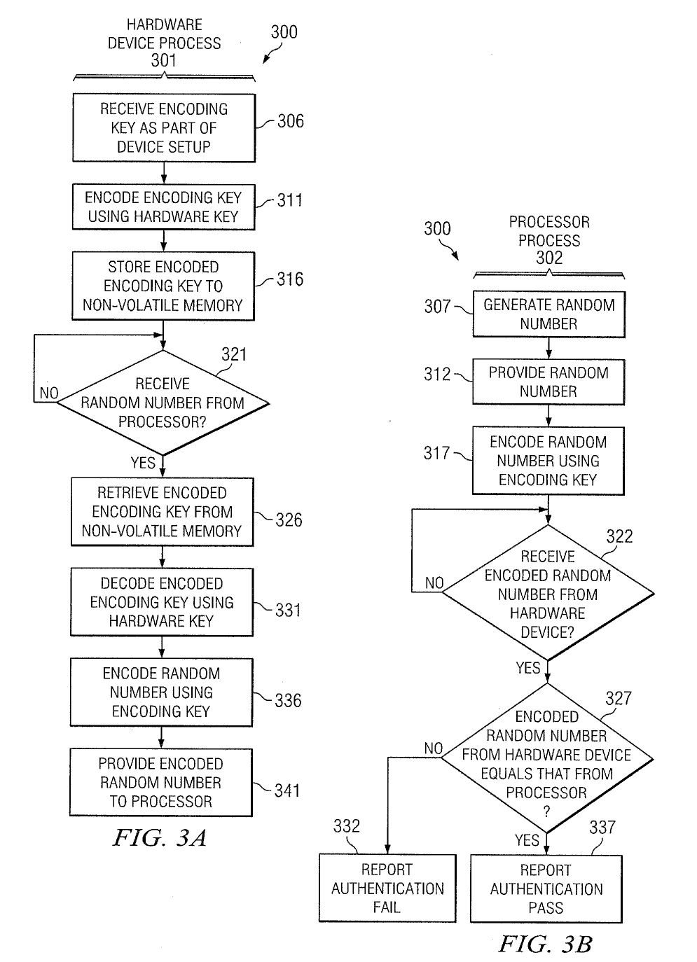

Turning to FIG. 2, a hardware based encryption system 200 in accordance with some embodiments of the present invention is depicted. Hardware based encryption system 200 includes a processor 210, a hardware device 230, and a flash memory 295. In some cases, flash memory 295 is embedded in hardware device 230. In other cases, flash memory is replaced with some other type of non-volatile memory such as, for example, an electrically erasable read only memory or the like. Based on the disclosure provided herein, one of ordinary skill in the art will recognize a variety of memory types that may be used in placed of flash memory 295.

Processor 210 may be any device capable of providing control and/or requests to hardware device 230. Thus, for example, processor 210 may be any microprocessor known in the art that is capable of executing software/firmware instructions. Processor 210 includes three software modules: a random number generator 212, and an encoding module 214. In addition, processor 210 includes an encoding key 216. Random number generator 212 may be any hardware or software based system that is capable of generating a random number or pseudo-random number as are known in the art. In some cases, random number generator 212 may be replaced with a message generator that is capable of producing some data set that may be transferred to hardware device 230 in place of the random number. It should be noted that random number generator 212 may be included as part of hardware device 230. In such a case, hardware device 230 would generate a random number that would be provided to processor 210.

Processor 210 is communicably coupled to hardware device 230 via a data bus 220. Encoding module 214 may be any encoding approach known in the art that can be replicated on hardware device 230. In one particular embodiment of the present invention, encoding module may be a software module that is executable to encode a presented data set using an encoding key. As one example, the encryption may be a Data Encryption Standard (DES) developed originally by IBM and adopted as a federal standard in 1976 by the National Institute of Standards and Technology (NIST). Alternatively, the encryption may be a more secure Triple Data Encryption Standard (Triple DES). Both DES and Triple DES are well known in the art. Based on the disclosure provided herein, one of ordinary skill in the art will recognize a myriad of known key based encryption standards that may be used in relation to different embodiments of the present invention. In some cases, one or more of the aforementioned modules may include computer executable instructions maintained in a memory 218 (shown in dashed lines) along with encoding key 216.

Hardware device 230 may be any device capable of communicating with a processor. Thus, as just one of many examples, hardware device 230 may be a battery controller associated with one or more battery cells that provide power to a system controlled by processor 210. In such a case, processor 210 may be associated by, for example, a cellular telephone, personal digital assistant, or laptop computer that are powered by the battery. Based on the disclosure provided herein, one of ordinary skill in the art will recognize a variety of hardware devices that may employ encryption and/or decryption technology in accordance with embodiments of the present invention.

Hardware device 230 includes a processor interface 235 that is capable of receiving data from processor 210 via data bus 220, and for providing data to processor 210 via data bus 220. In one particular embodiment of the present invention, data bus 220 is a PCI bus, and processor interface 235 is a PCI interface. In other embodiments, data bus 220 is an SMBus, and processor interface 235 is an SMBus interface. Based on the disclosure provided herein, one of ordinary skill in the art will recognize a variety of data buses and corresponding bus interfaces that may be used in relation to different embodiments of the present invention. Processor interface 235 provides data received from processor 210 to a hardware encode module 245 via an internal data bus 236 and to a message encode module 240 via an internal data bus 238, albeit not necessarily at the same time. In addition, processor interface 235 receives data for transfer to processor 210 from message encode module 240 via an internal data bus 237. Message encode module 240 is operable to encode using the same encryption standard chosen to perform the encoding by encoding module 214 associated with processor 210.

Hardware device 230 additionally includes a hard coded hardware key 250. Hardware key 250 may be a number of flip-flops that are electrically tied to provide a determined output pattern. In one particular embodiment of the invention, hardware key 250 includes sixteen flip-flops that are electrically connected to supply or ground to provide a desired sixteen bit pattern (e.g., 0xFA0E). In other embodiments of the present invention, hardware key 250 may include a number of fuses that may be selectably blown to provide a desired pattern. Thus, for example, hardware key 250 may include thirty-two fuse pairs with one of each of the fuse pairs electrically coupled to supply and the other of the fuse pairs electrically coupled to ground. During manufacturing of hardware device 230, one or the other of each of the fuse pairs may be selectably blown to create a desired thirty-two bit pattern (e.g., 0xF0F0F0F0). Based on the disclosure provided herein, one of ordinary skill in the art will recognize a variety of other implementations of hardware key 250 that may be used in relation to different embodiments of the present invention.

Hardware key 250 is provided to both hardware encode module 245 and a hardware decode module 255. Hardware encode module 245 encodes information based on hardware key 250, and hardware decode module 255 reverses the encoding of hardware encode module 245 using the same hardware key 250. Hardware encode module 255 may implement any key based encoding algorithm known in the art. For example, hardware encode module 245 may shift data to be encoded either right or left in a wrap-around fashion based on particular bits of hardware key 250. In turn, the reverse shifting process may be employed by hardware decode module 255. As another example, hardware encode module 245 may XOR a received data set with hardware key 250, and hardware decode module 255 may substantially reverse the process to retrieve the originally provided information. Based on the disclosure provided herein, one of ordinary skill in the art will recognize a variety of encoding/decoding processes that may be employed in relation to different embodiments of the present invention.

Hardware encode module 245 provides an encoded output to a memory read/write control module 260 via a data bus 247. In turn, memory read/write control module 260 is responsible for writing the encoded output to flash memory 295 via a memory interface bus 270. Memory read/write control module 260 may read the encoded output back from flash memory 295 via memory interface bus 270, and provide the encoded output to hardware decode module 255 via a data bus 257. After decoding the encoded output to create a decoded output, hardware decode module 255 provides the decoded output to message encode module 240. Where the decode output corresponds to encoding key 216 associated with processor 210, message encode module 240 may encode a message for processor using an encoding key that is known to processor 210.

While it may thus be possible to encode using an encoding key known to processor 210, the encoding key is not accessible through the relatively simple reverse engineering of flash memory 295 as the encoding key is not maintained in an un-encoded format in flash memory 295. Thus, as just one advantage of some embodiments of the present invention, encoding between processor 210 and hardware device 230 may be performed without placing the encoding key in a relatively vulnerable condition—un-encoded in flash memory 295.

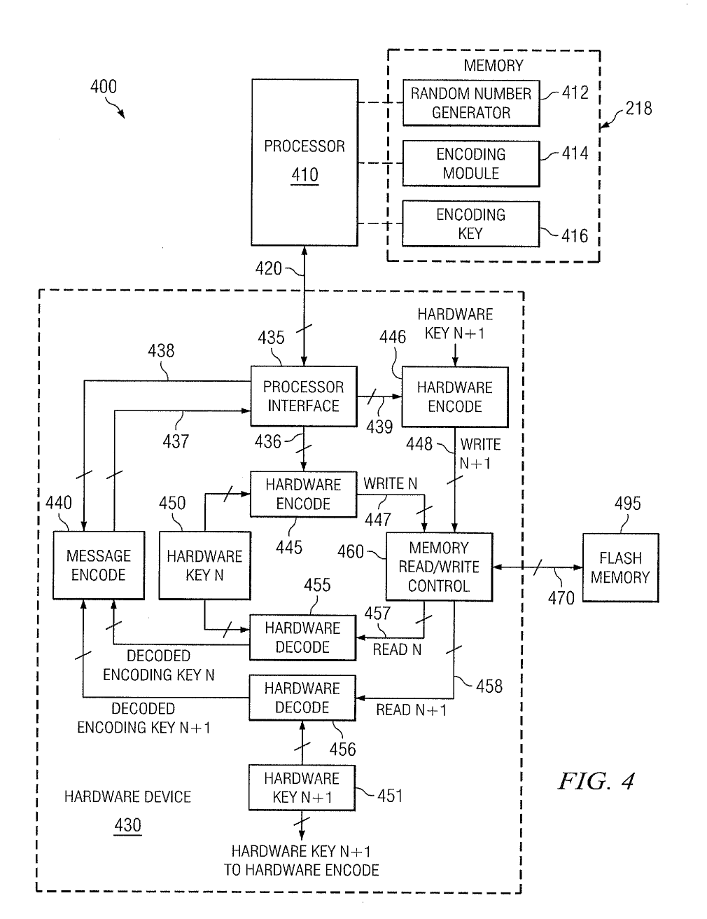

FIG. 3 is a flow diagram 300 showing a method for device authentication using hardware based encryption in accordance with one or more embodiments of the present invention. It should be noted that the method of flow diagram 300 may be used in relation to a variety of hardware based encryption systems, but for discussion purposes it is discussed with particular reference to hardware based encryption system 200. Flow diagram 300 includes a hardware device process 301 and a processor process 302. In the discussed example, hardware device process 301 includes a number of processes that are performed by hardware device 230, and processor process 302 includes a number of processes that are performed by processor 210.

Following flow diagram 300, an encoding key is written to a hardware device (block 306). This may include, for example, causing an encoding key to be written to hardware device 230 via data bus 220. The received encoding key is encoded by the hardware device (block 311) and the encoded encoding key is written to a non-volatile memory (block 316). This may include, for example, passing the encoding key from processor interface 235 to hardware encode module 245 via data bus 236. Hardware encode module 245 then encodes the received encoding key using hardware key 250. The encoded encoding key is provided to memory read/write control module 260 via data bus 247, and memory read/write control module 260 writes the encoded encoding key to flash memory 295. It should be noted that in alternative embodiments of the present invention that the encoding module may be eliminated by originally passing an encoded encoding key to the hardware device. Thus, the encoded encoding key could be passed directly to the memory without being encoded.

A processor or other controlling device generates a random number (block 307), and provides the un-encoded random number to the hardware device (block 312). This may include, for example, causing processor 210 to execute random number generator module 212, and send the generated random number to hardware device 230 via data bus 220. In addition, the processor encodes the generated random number using the encoding key and stores the encoded random number for later comparison (block 317). This may include, for example, causing processor 210 to execute encoding module 214 using encoding key 216. It should be noted that in alternative embodiments of the present invention that the random number may be generated on the hardware device and provided to the processor where it could be encoded and used for comparison purposes as discussed below.

It is determined by the hardware device whether a random number has been received from the processor (block 321). Again, it may be the case that the processor generates a message in place of the random number. In such a case, the succeeding processing may be performed on the received message in place of the random number. Where the random number (or other message) has not yet been received (block 321), the process stalls. Alternatively, where the random number (or other message) has been received (block 321), the processing continues.

In particular, the previously stored encoded encoding key (see block 316) is retrieved from the non-volatile memory (block 326). This may include, for example, causing memory read/write control module 260 to access flash memory 295 and retrieve the encoded encoding key. This encoded encoding key is passed to hardware decode module 255 via data bus 257. The encoded encoding key is decoded using a hardware key (block 331), and the recovered encoding key may then be used to encode the received random number (or alternative message) (block 336). This may be done, for example, by hardware decoding module 255 using hardware key 250, and passing the recovered encoding key to message encode module 240. Message encode module 240 then encodes the received random number (or alternative message) using the recovered encoding key (block 336). The encoded random number (or alternative message is then passed to the processor (block 341).

The processor awaits reception of the encoded information (block 322). When the processor receives the encoded information (block 322), the encoded information received from the hardware device is compared against the encoded information previously created by the processor (block 327). Of note, the recovered encoding key used by the hardware device to encode the information (block 336) corresponds to the encoding key used by the processor to perform the encoding of the random number (or alternative message)(block 317). Thus, the encoding performed in block 336 and that performed in block 317 will yield an equivalent result where the encoding key recovered from the non-volatile memory is that expected by the processor. Thus, where the two sets of encoded information match (block 327), the authentication process is considered successful (block 337). Alternatively, where the two sets of encoded information do not match (block 327), the authentication process fails (block 332).

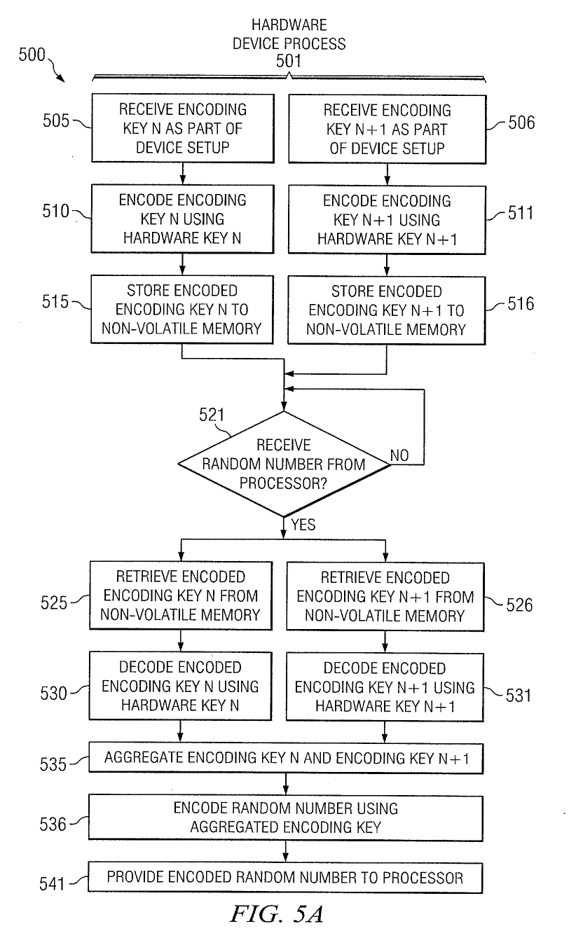

FIG. 4 depicts another hardware based encryption system 400 in accordance with other embodiments of the present invention. Hardware based encryption system 400 includes a processor 410, a hardware device 430, and a flash memory 495. In some cases, flash memory 495 is embedded in hardware device 430. In other cases, flash memory is replaced with some other type of non-volatile memory such as, for example, an electrically erasable read only memory or the like. Based on the disclosure provided herein, one of ordinary skill in the art will recognize a variety of memory types that may be used in placed of flash memory 495.

Processor 410 may be any device capable of providing control and/or requests to hardware device 430. Processor 410 includes three software modules: a random number generator 412, and an encoding module 414. In addition, processor 410 includes an encoding key 416. Random number generator 412 may be any hardware or software based system that is capable of generating a random number or pseudo-random number as are known in the art. In some cases, random number generator 412 may be replaced with a message generator that is capable of producing some data set that may be transferred to hardware device 430 in place of the random number. Processor 410 is communicably coupled to hardware device 430 via a data bus 420. Encoding module 414 may be any encoding approach known in the art that can be replicated on hardware device 430. Based on the disclosure provided herein, one of ordinary skill in the art will recognize a myriad of known key based encryption standards that may be used in relation to different embodiments of the present invention. In some cases, one or more of the aforementioned modules may include computer executable instructions maintained in a memory 418 (shown in dashed lines) along with encoding key 416.

Hardware device 430 may be any device capable of communicating with a processor. Hardware device 430 includes a processor interface 435 that is capable of receiving data from processor 410 via data bus 420, and for providing data to processor 410 via data bus 420. Processor interface 435 provides data received from processor 410 to a hardware encode module 445 via an internal data bus 436, to another hardware encode module 446 via an internal data bus 439, and to a message encode module 440 via an internal data bus 438. In addition, processor interface 435 receives data for transfer to processor 410 from message encode module 440 via an internal data bus 437. Message encode module 440 is operable to encode data using the same encryption standard chosen to perform the encoding by encoding module 414 associated with processor 410.

Hardware device 430 additionally includes a first hard coded hardware key 450 and a second hard coded hardware key 451. Based on the disclosure provided herein, one of ordinary skill in the art will recognize a variety of approaches that may be used to implement hardware keys 450, 451 in relation to different embodiments of the present invention. Hardware key 450 is provided to both hardware encode module 445 and a hardware decode module 455; and hardware key 451 is provided to both hardware encode module 446 and a hardware decode module 456. Hardware encode module 445 encodes information based on hardware key 450, and hardware decode module 455 reverses the encoding of hardware encode module 445 using the same hardware key 450. Similarly, hardware encode module 446 encodes information based on hardware key 451, and hardware decode module 456 reverses the encoding of hardware encode module 446 using the same hardware key 451. Hardware encode modules 455, 456 may implement any key based encoding algorithm known in the art. For example, hardware encode modules 445, 446 may shift data to be encoded either right or left in a wrap-around fashion based on particular bits of the respective hardware keys 450, 451. In turn, the reverse shifting process may be employed by hardware decode modules 455, 456. Based on the disclosure provided herein, one of ordinary skill in the art will recognize a variety of encoding/decoding processes that may be employed in relation to different embodiments of the present invention. Further, it should be noted that hardware encode module 445 and hardware encode module 446 may implement different encoding algorithms. In such a case, hardware decode module 455 is designed to reverse the process of hardware encode module 445, and hardware decode module 456 is designed to reverse the process of hardware encode module 446. For example, hardware encode module 445 may be designed to XOR a received data set with hardware key 450, and hardware decode module 455 may substantially reverse the process to retrieve the originally provided information; and hardware encode modules 446 may shift data to be encoded either right or left in a wrap-around fashion based on particular bits of hardware key 451, and hardware decode module 456 may reverse the aforementioned shifting process based on the same hardware key 451.

Hardware encode module 445 provides an encoded output representing one portion of the encoding key to a memory read/write control module 460 via a data bus 447. Similarly, hardware encode module 446 provides an encoded output representing another portion of the encoding key to memory read/write control module 460 via a data bus 448. In turn, memory read/write control module 460 is responsible for writing the two encoded portions to flash memory 495 via a memory interface bus 470. Memory read/write control module 460 may read the respective portions of the encoded encoding key back from flash memory 495 via memory interface bus 470, and provide the encoded outputs to the respective hardware decode module 455 via a data bus 457 and hardware decode module 456 via a data bus 458. In particular, the portion originally encoded by hardware encode module 445 is provided to hardware decode module 455, and the portion originally encoded by hardware encode module 446 is provided to hardware decode module 456.

After decoding its portion of encoded output to create a decoded output, hardware decode module 455 provides the portion (i.e., decoded encoding key N) of the decoded output to message encode module 240. Similarly, after decoding its portion of encoded output to create a decoded output, hardware decode module 456 provides the portion (i.e., decoded encoding key N+1) of the decoded output to message encode module 240. Message encode module 440 aggregates the two portions of the encoding key. In some cases, the first portion of the encoding key is the first half of the encoding key and the second portion of the encoding key is the second half of the encoding key. In this case, the aggregating process is as simple as appending the portion (i.e., decoded encoding key N) from hardware decode module 455 to the portion from hardware decode module 456 (i.e., decoded encoding key N). In other cases, the first portion (i.e., decoded encoding key N) of the encoding key is the even bits of the encoding key and the second portion (i.e., decoded encoding key N+1) of the encoding key is the odd bits of the encoding key. In such a case, the aggregating process includes inter-mixing the two portions. Based on the disclosure provided herein, one of ordinary skill in the art will recognize a variety of processes for portioning the encoding key, and corresponding approaches for aggregating the portions. Where the aggregated encoding key corresponds to encoding key 416 associated with processor 410, message encode module 440 may encode a message for processor using an encoding key that is known to processor 410.

While it may thus be possible to encode using an encoding key known to processor 410, the encoding key is not accessible through the relatively simple reverse engineering of flash memory 495 as the encoding key is not maintained in an un-encoded format in flash memory 495. Indeed, in this case, the encoding key may be encoded in separate portions where each portion is encoded using the same encryption algorithm and the same hardware key, the same encryption algorithm and different hardware keys, using different encryption algorithms using the same hardware key, or using different encryption algorithms using different hardware keys. This provides an additional layer of complexity rendering the encoding key less susceptible to hacking. It should also be noted that while system 400 shows the encoding key broken into two portions, the encoding key could be divided into three or more portions to yield and even higher level of security. Thus, as just one advantage of some embodiments of the present invention, encoding between processor 410 and hardware device 430 may be performed without placing the encoding key in a relatively vulnerable condition—un-encoded in flash memory 495 or even a unified encoded form.

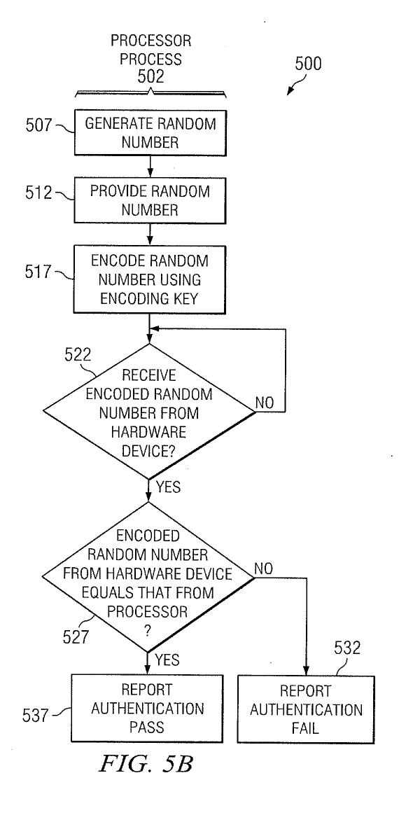

Turning to FIG. 5, a flow diagram 500 shows another method for device authentication using hardware based encryption in accordance with other embodiments of the present invention. It should be noted that the method of flow diagram 500 may be used in relation to a variety of hardware based encryption systems that provide for two or more encryption/decryption paths, but for discussion purposes it is discussed with particular reference to hardware based encryption system 400. Flow diagram 500 includes a hardware device process 501 and a processor process 502. In the discussed example, hardware device process 501 includes a number of processes that are performed by hardware device 530, and processor process 502 includes a number of processes that are performed by processor 510.

Following flow diagram 500, an encoding key is written to a hardware device in two portions (blocks 505, 506). This may include, for example, causing a first portion (i.e., decoded encoding key N) and a second portion (i.e., decoded encoding key N+1) of an encoding key to be written to hardware device 430 via data bus 420. As discussed above, the portions may be contiguous portions or non-contiguous portions. In any event, a later aggregation process (see block 535) is set up to reverse the aforementioned portioning process. One portion of the received encoding key is encoded by an encoder included with the hardware device (block 510), and the other portion is encoded by another encoder include with the hardware device (block 511). The two encoded portions of the encoding key are then written to a non-volatile memory either at contiguous locations or at separate locations (blocks 515, 516). This may include, for example, passing the encoding key from processor 401 in two separate portions via processor interface 435. In turn, processor interface 435 passes one of the portions to hardware encode module 445 and the other portion to hardware encode module 446. Hardware encode module 445 then encodes the received portion of the encoding key using hardware key 450, and hardware encode module 446 encodes the received portion of the encoding key using hardware key 451. Both encoded portions are then written to flash memory 495 under control of memory read/write control module 460.

A processor or other controlling device generates a random number (block 407), and provides the un-encoded random number (or other message) to the hardware device (block 512). This may include, for example, causing processor 410 to execute random number generator module 412, and send the generated random number (or other message) to hardware device 430 via data bus 420. In addition, the processor encodes the generated random number using the encoding key and stores the encoded random number for later comparison (block 517). This may include, for example, causing processor 410 to execute encoding module 414 using encoding key 416.

It is determined by the hardware device whether a random number (or other message) has been received from the processor (block 521). Where the random number (or other message) has not yet been received (block 521), the process stalls. Alternatively, where the random number (or other message) has been received (block 521), the processing continues.

In particular, the previously stored encoded portions of the encoding key (see blocks 515, 516) are retrieved from the non-volatile memory (blocks 525, 526). This may include, for example, causing memory read/write control module 460 to access flash memory 495 and retrieve the first portion (i.e., encoded encoding key N) and the second portion (i.e., encoded encoding key N+1) or the encoded encoding key. The first portion and second portions are provided to a respective one of hardware decode module 455 and hardware decode module 456 that corresponds to the hardware encode module originally used to encode the portion. The portions are then decoded by the respective hardware decoded module (blocks 530, 531). The recovered portions of the encoding key are then aggregated to form the original encoding key (block 535). This may include, for example, passing the portions of the decoded encoding key (i.e., decoded encoding key N and decoded encoding key N+1) to message encode module 440 where the portions are aggregated. Message encode module 240 then encodes the received random number (or alternative message) using the recovered encoding key (block 536). The encoded random number (or alternative message is then passed to the processor (block 541).

The processor awaits reception of the encoded information (block 522). When the processor receives the encoded information (block 522), the encoded information received from the hardware device is compared against the encoded information previously created by the processor (block 527). Of note, the recovered encoding key used by the hardware device to encode the information (block 536) corresponds to the encoding key used by the processor to perform the encoding of the random number (or alternative message)(block 517). Thus, the encoding performed in block 536 and that performed in block 517 will yield an equivalent result where the encoding key recovered from the non-volatile memory is that expected by the processor. Thus, where the two sets of encoded information match (block 527), the authentication process is considered successful (block 537). Alternatively, where the two sets of encoded information do not match (block 527), the authentication process fails (block 532).

In conclusion, the present invention provides novel systems, devices, methods and arrangements for hardware based encryption/decryption. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the scope of the invention.

What is claimed is:

1. A method for authenticating a hardware device comprising:
generating a random message by a processor;
encoding the random message with a first set of keys to generate a first encoded message;
transmitting the random message from the processor to the hardware device;
retrieving second set of keys from a non-volatile memory by the hardware device, wherein the second set of keys are hardware encoded;
decoding the second set of keys with a set of hardware keys;
encoding the random message with the second set of keys to generate a second encoded message;
transmitting the second encoded message to the processor;
comparing the first encoded message and the second encoded message by the processor; and
reporting an authentication failure if the first and second encoded messages do not match.

2. The method of claim 1, wherein the first set of keys further comprises a first key and a second key, and wherein the second set of keys further comprises a third key and a fourth key.

3. The method of claim 2, wherein step of encoding the random message with the first set of keys further comprises:
encoding a first portion of the random message with the first key; and
encoding a second portion of the random message with the second key.

4. The method of claim 3, wherein step of encoding the random message with the second set of keys further comprises:
encoding the first portion of the random message with the third key; and
encoding the second portion of the random message with the fourth key.
